(19) United States
(12) Patent Application Publication
(10) Pub. No.: US 2014/0372910 A1
(43) Pub. Date: Dec. 18, 2014

(54) System and Method of Collecting and Compiling Media

(71) Applicants: Peyton Alford Mandzic, Atlanta, GA (US); Lauren Ralph, Delmar, NY (US); Jason Ralph, Delmar, NY (US)

(72) Inventors: Peyton Alford Mandzic, Atlanta, GA (US); Lauren Ralph, Delmar, NY (US); Jason Ralph, Delmar, NY (US)

(21) Appl. No.: 14/209,994

(22) Filed: Mar. 13, 2014

Related U.S. Application Data
(60) Provisional application No. 61/786,402, filed on Mar. 15, 2013.

(51) Int. Cl. G06F 3/0484; H04L 29/08; G06F 3/0481

(52) U.S. Cl. CPC G06F 3/04842; G06F 3/0481; H04L 67/10
USPC 715/753

(57) ABSTRACT

A system and method allowing a user to collect and compile media from other users to create a personalized, themed, collaborative, final product such as a photo book, book of thoughts, cards, video/slideshow, calendar, or other content, photo or video-based product. Contributor users can be guided on what media and content to submit, creating a final product that is more meaningful than prior personalized/themed products. An organizer user can outline the project, choose a theme (by directing and guiding contributor users on what content to contribute), invite contributor users, set preferences, manage communications, and track receipt of media, and then efficiently organize contributed media to efficiently and effectively create a meaningful, final, collaborative product.

### CROSS-REFERENCE TO RELATED APPLICATION

This application claims priority to U.S. Provisional Patent Application No. 61/786,402, filed Mar. 15, 2013, entitled, “System and Method for Collecting and Compiling Media,” which is hereby incorporated by reference in its entirety.

### BACKGROUND OF THE INVENTION

1. Field of the Invention

People often desire to collect memories or thoughts for a particular event or milestone, such as a birthday, anniversary, holiday, anniversary, etc., in an organized fashion and compile it into a meaningful final product. For example, people have used photo albums to collect and compile photos for a particular event to commemorate the event and reflect upon others and their impact on their lives. People also desire to collect media, thoughts, and memories from people scattered across the globe in an organized and efficient manner. By typical processes, this collection and compilation of media takes a long time.

This task of collecting different media, especially from multiple people, and compiling it into something meaningful is not only time-consuming but can be overwhelming. Getting people to create funny, sentimental or meaningful content for a final product can also be difficult because people don't know what to say or write and are often at a loss for words when writing messages to loved ones.

Creating a final product of cohesive content can also be difficult. One may ask the contributor to write a nice card or bring a gift, but the contributor often doesn't know how to organize a cohesive, commonly-themed gift from the group of contributors.

Collecting media from various sources in an organized way and compiling it into a personalized final product can be daunting. Accordingly, there is a need for a system and a method to collect and compile media in an organized way, and one that can evoke thoughts and memories to add personalization to create a meaningful, final, collaborative product.

The present invention relates to a method of collecting and compiling media and creating a personalized, collaborative, final product, such as a photo album or scrapbook, photo book, book of text, video or the like. A graphical user interface (GUI) can be used navigate and access the system and utilize the related method. The system and method improves on the prior art by making the process faster, more efficient, and easier for all users involved. The present invention also creates an improved final product by guiding users on what content and or media to submit by having a theme and setting deadlines to help the users get all media in a timely manner.

2. Description of the Related Art

Examples of other systems include U.S. Pat. No. 7,296,023, entitled “Method and Apparatus for Persistent Real-Time Collaboration,” U.S. Pat. No. 8,364,755, entitled, “System for Digital Yearbook with Social Networking,” U.S. Pat. No. 8,554,020, entitled, “System and Method for Creating and Sharing Photo Stories,” U.S. Patent Publication No. 2011/0066945, entitled “Video Greeting Cards,” U.S. Patent Publication No. 2013/0061135, entitled, Personalized Memory Compilation for Members of a Group and Collaborative Method to Build a Memory Compilation,” U.S. Patent Publication No. 2009/0070426 entitled, “Content Contribution and Placement Through External Social Communities,” and U.S. Patent Publication 2012/0054589 entitled, “System and Method for an Online Memories and Greeting Service.” The aforementioned US patents and Published patent application are hereby incorporated by reference in their entireties. However, none of these address the issues solved by the present invention described herein.

### SUMMARY OF THE INVENTION

The present invention generally relates to a system and method that streamlines the collection of various media often from various people and simplifies compilation of such media into a meaningful final product. The system and method can employ a graphical use interface (GUI).

Media can be collected for a particular event, such as a birthday, holiday, thank-you gift, anniversary, baby shower, wedding, engagement, group trip, memorial or any other life event, but does not necessarily have to be related to one particular event.

Media can be in the form of video, audio, text, pictures, photographs, electronic artwork, photo story, photo book, photo book page(s), online photo book, card, electronic card, message, calendar, portion of a calendar, website, webpage, any photo or video product, a portion of any photo or video product, or the like, but are not limited to such.

The final collaborative product may be in the form of a book, photo book, memory book, slideshow, video montage, movie, electronic file, series of emails, audio file, card, series of cards, or any combination thereof, but are not limited to such. The final product can be a gift to an individual, a group of individuals, a company, or other entity. The final product could also be used as internal or external promotional material or advertising for an organization or business.

In one embodiment, the present invention provides a theme or questions to a user to spur the memory of the user and to facilitate personalization. This will be referred to herein as the “Question and Answer” (“Q&A”) format. It also helps evoke thoughts, advice and memories to help people create meaningful content through the Q&A piece.

In another embodiment, “sample” contributions can be provided on the screen to guide a user (contributor).

To simplify payment, a payment component can also be included. An account management system with login features can also be included. Connection and integration with social media websites to collect or share various media is another aspect of the present invention. Photo editing features may also be incorporated.

Users of the present invention can be an individual or corporate entity. Not to limit the type of users but for simplicity only, the users are discussed herein as being of two general types: “organizer” and “contributors.” For example, “organizer” could be called “leader,” “project-leader,” “initiator,” “gift-giver,” “first user” or the like. The “contributor(s)” could also be called “donors,” “gift-givers,” “second user(s)” or the like. The “organizer” generally is the one who initiates the project, sets up a project, makes decisions on the final product, such as the format and style, makes a final decision on who the “contributors” are, and manages the project.

The system and method described herein can be implemented on a website, a partner or other company's website, integrated into software, integrated into a physical retail store's software, integrated into a gift or photo-related software. The software can be video creation or editing software. The present invention can be integrated into media analysis or metaview software. The system and method can also be integrated into a user interface on a website, phone apps, TV apps, tablet (such as iPad®) apps.

The present invention provides a computer-implemented method to create a collaborative product, the method comprising: selecting, by a first user, one or more second users to contribute media to the collaborative product; establishing, by said first user, at least one parameter for the collaborative product; establishing, by said first user, at least one parameter for the media to be contributed; selecting, by said first user, a theme for the collaborative product; contributing, by said one or more second users, media for the collaborative product; and using, by said first user, one or more second user's media to create the collaborative product.

The present invention also provides a computerized system capable of creating a collaborative product, the system comprising: means for a first user to select one or more second users to contribute media to the collaborative product; means for the first user to establish at least one parameter for the collaborative product; means for the first user to establish at least one parameter for the media to be contributed; means for the first user to select a theme for the collaborative product; means for the one or more second users to contribute media for the collaborative product; and means for the first user to use one or more second user's media to create the collaborative product.

The collaborative product can be one or more of a video, personalized book of text, slideshow, video montage, audio file, calendar, collage, newsletter, mixed media story, cards, series of printed cards or series of e-cards, slideshow, video montage, audio file, photo book, scrapbook, or photo album.

The media can be one or more of video, audio, text, pictures, photographs, electronic artwork, digital or online album, photo album, photo story, photo book, photo book page(s), online photo book, card, electronic card, collage, newsletter, invitation, message, calendar, portion of a calendar, website, webpage, any photo or video product, a portion of any photo or video product.

The at least one parameter can be one or more of the following: recipient, event, theme, date of the event, project name, specific questions to be answered, how many or few questions to answer, format of contributions, deadlines, type of media, minimum amount of media, maximum amount of media, number of characters in text, number of pages, minimum video time, maximum video time, names of second users, number of second users, information relating to second users, type and format of the collaborative product(s), and degree to which second users may edit their assigned portion of the collaborative product.

Questions relating to said theme can be posed to said one or more second users.

The first user can limit the amount of media contributed by the one or more second users.

The media can be associated with one or more second users who contributed said media and said association is communicated to said first user.

The first user can edit parameters and said one or more second users is able to edit media.

The contributed media can be loaded into a product creation area for said first user to view and select from.

A graphical user interface can be used by said first user to view and monitor contributions.

### BRIEF DESCRIPTION OF THE DRAWINGS

FIG. 1 is an exemplary GUI for an organizer to begin a project with;

FIG. 2 is an exemplary GUI for an organizer relating to theme choice;

FIG. 3 is an exemplary GUI for an organizer relating to theme choice in more detail;

FIG. 4 is an exemplary flowchart of the system of the present invention;

FIG. 5 is an exemplary photo book creation area showing assignment of pages to various contributors;

FIG. 6 is an exemplary GUI which enables hiding/showing media by a contributor;

FIG. 7 is an exemplary GUI showing setting of various parameters;

FIG. 8 is an exemplary GUI used by an organizer for obtaining video contributions;

FIG. 9 is an exemplary phone application a contributor can use to record a contribution;

FIG. 10 is an exemplary phone application showing a scrolling feature a contributor can use to read a contribution;

FIG. 11 is an exemplary phone application where a contributor can play a video and choose whether to redo the contribution or submit/upload the contribution;

FIG. 12 is an exemplary dashboard of an organizer to track the status of contributions; and

FIG. 13 is an exemplary system diagram.

### DETAILED DESCRIPTION OF THE INVENTION

One aspect of the present invention relates to organization of the media being collected. To facilitate such organization, a user or “organizer” can lead the project and make decisions about various aspects of the collection and final product. For example, the organizer can make decisions such as (1) who the other users will be; (2) what other users will contribute; (3) how much they can contribute; (4) specifications of the final product; and (5) how contributed media will be used in the final product. The other users for purposes of this embodiment will be called “contributors” but there can be users that do not necessarily contribute.

Another aspect of the present invention relates to the manner in which information and/or media is collected. In one embodiment, this information can be collected using a question and answer format, where the questions relate to the chosen theme. Questions are generated and stored for use by the user or they can be input by a user or pulled from the system's database of questions. Questions can be categorized in various ways, such as “Funny,” “Sentimental” or “Advice.” Questions may also be offered in dropdown box format. Questions can be in the form of an open statement. Questions can also be directions such as “write a letter to your coach telling him why you enjoyed this past year and what you learned.”

Another aspect of the present invention relates to the entry creation part in which a contributor can add, edit and save media and text in an entry. Contributors can also submit media to a project without creating an entry.

Another aspect of the present invention relates to notification of other's contributions. Contributors may choose to be emailed about other user's/contributor's contributions. E-cards may be used to notify users of such activities.

Contributors may choose to keep all or part of their contributions private from certain individuals.

The present invention can be used for group use and individual use. In one embodiment, a user can create a photo book for another individual to commemorate her baby shower by collecting various media from a group of individuals. For example, this group of individuals may comprise of attendees of the baby shower but could also include other family and friends. The user (organizer) can invite the attendees of the baby shower and other family and friends to contribute. In another embodiment, a user can create a 60^{th} birthday montage for her mother and invite all the family members and friends to contribute.

In another embodiment, an individual can also collect his or her own media to give as a gift to another individual, i.e., without necessarily collecting information from other users. For example, a husband can create a gift for his wife for an anniversary. In this embodiment, the question and answer aspect of this invention could be used to give the husband ideas. Another example may be a mother giving a gift to her child.

The invention may allow users to integrate data to and from other sources such as iTunes®, Shutterfly®, Vimeo®, Twitter®, etc. For example, a user could access one of their iTunes® songs to use in a video or purchase a song from iTunes to use in a final product.

Keeping the contributions secret to all involved as well as the Recipient is key, with only the Organizer seeing others contributions.

There are several aspects of this invention, not limited to, but including the following: the organizational structure, the Q&A, the entry creating, marketing, and the product creation as discussed below.

### Organization

The organizational structure allows a user (organizer) to provide information about the gift they would like to give. The organizer can choose the type of gift (photo book, video montage (movie/slideshow), series of e-cards, series of printed cards, or any combination thereof). The organizer can also choose the type of event the gift the product is for (anniversary, memories of a trip, birthday, memorial, bar/bat mitzvah, etc.). The organizer can also provide details of the gift recipient, such as name, gender, email address, age, nickname, and relationship to the contributor. Information such as brides name and grooms name may also be entered. Information collected here may be used by the system to suggest certain questions (from the Q&A) and aesthetics for the project. The organizer can also provide gift delivery details, for example, when and to who the photo book should be delivered, the frequency that a recipient receives e-cards, and times for delivery.

In accordance with an embodiment of the invention, the organizer can personalize messages to other users about the contribution, gift, event, etc. Other email notification for notifying contributors of various events and deadlines can also be included. The organizer can choose overall product aesthetics, such as book size, book cover, finish, number of pages, embellishments (digital decorations), color themes, interim pages, background themes, page layouts, music type, length, slide timing, animation, formatting, etc.

One way this may work is for the Organizer to enter information about an event, recipient, or theme. She may enter the recipients name, recipients picture/image/audio/video, Recipients nickname, gender, age, her relationship to the recipient, other contacts or peoples relationships to the Recipient, or other information. These details may be pulled from or pushed to a database containing information on users, friends, family members, or other contacts.

Another example relates to inviting contributors. A checkbox may exist to allow the Organizer to include herself as a Contributor. The Organizer may pull Contributors from a Contacts database, external social networks such as Facebook, external email networks such as Gmail, or enter them manually. She may add additional information to the information that is entered or pulled in. This additional information may include first name, middle name, last name, maiden name, email address, phone number, type of phone, preferred method of contact, birthdate, age, if the contact is a child or not, if she is a child then the approximate age, relationship to the Organizer, relationship to the Recipient, and or fields that allow the Organizer to indicate if someone else's contact information is being used and whose contact information it is. For example, if a child aged 5 years named Cindy is asked to be a contributor, her mother's email address and phone number may be entered as Cindy's contact information. The Organizer may check a checkbox showing that this contact information belongs to someone else. Another option may be for the Organizer to choose from a dropdown menu to whom the contact information belongs. Another option may be for this field or checkbox to appear if a birthdate is after a system or user specified date, indicating the contributor is a child. Another option may be for this field or checkbox to appear if the Organizer indicated the contributor is a child or other person desiring assistance with his contribution. For example, the Organizer may decide that a contributor such as a grandfather without an email address and or cell phone may require assistance from another Contributor, such as his daughter. The Organizer may request that his daughter submit his contribution and so the Organizer may use the daughters contact information.

A group pay feature may exist. An Organizer may select this feature if she wants Contributors to also contribute payment towards the gift or another gift. The Organizer may indicate that she requires or does not require a certain amount of payment from a Contributor if that Contributor wants his media to be part of the final product.

Another example relates to how the Organizer may monitor progress of the contributors contributions and the overall final product(s). This monitoring may be done with a dashboard type of GUI. The Organizer may choose to share the final product with all the Contributors after a certain date, such as the date of the event. The sharing may be done electronically or through physical embodiment like a book that can be mailed to the Contributor.

In another aspect of the invention, the emails/messages sent to contributors or the Contributor dashboard may automatically include the amount of media requested based on the theme. The amount of media can be specific or a range. For example, the Organizer has chosen the theme “50 Reasons We Love Mom”. The email to Contributors may request 5 Reasons each. Each contributor may access his Dashboard and submit answers to Questions 1-5. Questions may read, “Write Reason 1 that you love Mom”, “Write Reason 2 that you love Mom”, etc. An algorithm may be used to calculate how many questions each contributor should answer. As in this prior example, the algorithm may be formulated such that extra reasons are suggested in case the Organizer does not obtain enough to meet her theme. If the Organizer receives more reasons or answers than her theme dictates, she or the system automatically can put them onto an extra page/video space. For example, if the Organizer received a total of 55 Reasons the contributors love Mom and the theme is 50 Reasons (to celebrate a 50th birthday), then the Organizer or system can choose the 5 extra reasons to go onto another page titled “Plus a Few More Reasons we all Love you”.

Another example relates to how a Contributor may monitor progress of her contributions. This monitoring may be done with a Dashboard type of GUI. The Dashboard may list all the projects the Contributor is working on, has been invited to, has initiated, or has completed. The Dashboard may indicate if the user is a Contributor for that project, an Organizer, or both. The project name may be a clickable link that takes the user to another screen with details of that project. The theme or questions chosen by the Organizer may show on this screen or another Dashboard screen. The Dashboard may have a functionality that lets the user invite other Contributors if the Organizer has allowed it or suggest other Contributors to the Organizer. The Dashboard may show the Contributor how much more media she needs to contribute and what she has already contributed. It may show the deadline and calculate days left to contribute. It may show her progress to completion of full contribution with a thermometer like graph, a series of checks or Xs, a percent completed, a graph, chart, or other indicia showing progress. She may request to see sample contributions from the Dashboard or media contribution page.

Another example of the Dashboard may list the projects by Contributor connected with that users account information. For example, a mother's Dashboard may show that she has been asked to contribute to Grandma's 80th Birthday Book. It may also show that her daughter has been asked to contribute to Grandma's 80th Birthday Book and Ms. Kelly's Class Video. It may also show that her father has been asked to contribute to Grandma's 80th Birthday Book. The mother may click on each of these projects to access project details and enter contribution information and media. For example, when the mother accesses Ms. Kelly's Class Video details, she may see that her daughter has been invited to submit her favorite three pictures of the past school year and answer two questions about Ms. Kelly. The mother may ask her daughter these questions and type the daughter's answers in. The mother may also record the audio or video of her daughter answering the questions and submit it. These projects may also be listed under a general type of dashboard such as a “My Projects” webpage.

In another aspect of the invention, the Organizer may choose to extend the deadline for contributions for one, many or all contributors. She may choose different deadlines or extended deadlines for different contributors. She may do this from the Dashboard or Contributors screen.

In another aspect of the invention, details on media to contribute may or may not exist on the Set Contributor Parameters page. Fields for requested media details may be automatically created based on theme, and system suggestions, such as video length, may be automatically populated or entered by the Organizer. Media details such as number of questions to answer may or may not be communicated via email to contributors.

In another aspect of the invention, the Organizer may have a co-Organizer who may have the same authority or a degree of authority as the first Organizer.

Theme Feature with Question and Answer Feature

In one aspect, a theme may or may not be chosen. In another aspect, questions may or may not be chosen. In another aspect, both may be chosen. For example, the theme may be “Haircuts with Howard” and the questions may be “Describe your first haircut by Howard” and “Describe why Howard is a good barber.”

Another embodiment of the present invention is the question and answer format integrated into the system and method. An organizer can either choose from a set of pre-formulated questions or create his/her own question to pose to the other users (contributors). Instead or in addition to answering questions, an organizer can also choose to ask contributors to write a letter, complete a statement, or write about certain topics. Use of the word “Question” does not necessarily imply that it has to be a Question, but could be the answer to that question, a letter, a piece of advice, direction to write about a specific topic, etc. An organizer can also choose the number of questions posed to the other users (contributors) and manage the type of responses that can be entered by the other users. Different versions of a question and or different questions from the system's database may be provided depending on the age, sex, and relationship of the contributor. The organizer may also choose to allow the contributors to choose how many questions each wants to answer.

The Questions or theme that are suggested by the system may be connected to the Event Type. The Event Type may be manually chosen by a user or known from other systems, such as an invitation system. For example, for a 60th Birthday, questions may be geared towards what the Contributors have learned from this person or fond memories. If the event is for an anniversary, the Questions may be about memories of dating, the wedding, or the birth of children. The Questions or theme that are suggested by the system also may be connected to the Recipient, the gender of the Recipient, the age of the Recipient, the number of anticipated contributors, whether or not the event is deemed a “milestone” event such as a 50th anniversary, the deadline, the location of the event or other location, the Recipients hobbies or profession or job title, or a combination of these. For example, Bob may be retiring after 50 years of being a barber and the theme for his Group Retirement Book may be 50 Reasons Bob is a Great Barber, which could be a theme suggested by the system. The system may suggest this title based on the number of years Bob was employed as a barber (50), the name of the Recipient (Bob), and the profession of the Recipient (barber). The Organizer or another user may have manually entered this information or it may be known through other systems such as an invitation system. The theme may or may not be the title of the project. The system may use various information to suggest various themes to the Organizer. The themes may be presented in a dropdown menu. The themes may show various final products and samples once highlighted or selected. The theme or project may incorporate the final product type into its name, for example, Bob's Retirement Book. The final product may be chosen before or after a theme is selected or changed at anytime. Users may also use collected media to create other types of final products, such as using photos and text originally intended for a photo book now for a slideshow.

Another example relates to questions. Questions may be created or selected before or after a theme is chosen or regardless of whether a theme is chosen. Questions may be dynamically created by the system based on information. For example, if the theme is 80 Memories with Joyce and there are 8 invited contributors, the system may perform a calculation and suggest a question that asks each contributor for 10 Memories with Joyce for a total of 80 memories. Another example would be that the system automatically selects that each contributor will be asked to submit 10 Memories with Joyce if the Organizer has chosen the theme “80 Memories with Joyce”. The system may also use a different calculation to ask for more than 10 memories in case some contributors are not able to contribute or do not contribute enough memories.

Another example relates to who chooses the questions. The Organizer may decide that she wants every Contributor to answer a specific question. She may do this by selecting “Everyone answers this question” from a dropdown menu next to the field “Question 1”. Once chosen, a list of questions may appear from which she can select. After Question 1 is selected, a field for Question 2 may appear. The Organizer may select “Let every Contributor choose a question to answer” from a dropdown menu. This feature would allow each contributor to choose their own question for Question 2. The Organizer may or may not use the system to select potential questions she prefers for Question 2 and she may add her own potential questions. For Question 3, the Organizer may choose “Let me write my own question” where she would enter her question. The Organizer may also choose to let Contributors write their own questions. Once the question parameters are set, the questions and question information can be made available to Contributors on their Dashboard or through other contact.

Group Questions: The Organizer may choose to have a question that everyone answers. The final result may be something like a page in a book with the question or a related title at the top and each Contributor's answer listed below on that page. Each answer may be followed by the signature, name, or nickname of the Contributor.

Examples include: for Year in Review letter to friends and family for Holiday cards which may ask the card creator questions such as “Where did you go on vacation this year?” “What milestones did your children reach this year?” “What are each of your family members favorite holiday traditions?”; and questions about a child's likes/favorites on their birthday invitations.

The theme or question and answer feature directs Contributors on what to contribute and directs the Organizer on options for final product(s) and other related decisions.

### Entry Creation

In another aspect of the present invention, a user can have a dynamic space in which they can work to create a contribution. The user can, for example, select a background for their page. The contributor can upload media, add and edit text, and save his/her work. Limitations on the type of content and edits a contributor can make can depend on whether such limitations have been placed on the contributor by the organizer.

In another aspect of this invention, a user can create an entry using video. Depending on the decisions of the Organizer, the Contributor may be able to choose the Question he/she wants to answer. The Question the Contributor selected may appear in the Contribution area. The system of the present invention can encourage the Contributor to think about what he/she will say and perhaps type it out before recording. The Contributor may have a space to type or dictate an answer/Contribution, so that the Contributor may edit it to her liking, before she begins recording. The User Interface may show all the Questions/Contributions that are requested from the Contributor at once with answer spaces or it may only show only one Question and answer space per screen. The Contributor may be able to record her answer in the form of a video recording or herself and/or others. This recording may be done through a phone, phone app, Skype®, other video creation software/app, or on a computer with a webcam and microphone. Her Contribution that she has typed out and is reading may show on the screen as scrolling text or in chunks (similar to a teleprompter).

Multiple contributions could be made all together such as a couple or family recording their contribution together. They could indicate that both contributions were in the one recording. Any allotted time could be combined for people recording together.

In another aspect of this invention, the contributed media could be tagged with metadata or labeled with specific inputs such as “Contributor” or “Question Number”. This information may be used when the Organizer is creating the final product and only chooses to view media from specific contributors or questions. The information may also be used by the Organizer to assign pages or space to a specific contributor or question.

In another aspect of the invention, users may utilize facial recognition technology to find media for entries or part of the final product.

In another aspect of the invention, a contributor may contribute a portion of the requested media and submit it to the project. The contributor may choose not to submit all requested media by the deadline. The Organizer may use all or a portion of this media in the final product.

In an alternate embodiment, the Contributor may choose to upload photos or videos, and then answer the question with only an audio recording. The Contributor may then lay the audio answer over the pictures or videos in a video editing software that is or is not incorporated into our system. The Organizer or the Contributor may also have the ability to edit each audio file by cutting out parts and combining parts. The system of the present invention may also automatically integrate her audio and other media into a video template. The Contributor may also allow the Organizer to choose how to edit the audio and other media clips together or the Organizer may decide that she (the Organizer) will be the one to do this.

The system of the present invention may also help the Contributor make a better video by helping them look into the camera while recording. This creates a more emotional and meaningful contribution because the viewer of the video will perceive the Contributor as looking into their eyes while they say their Contribution. To do this, the Contributor may be asked where the camera is in relation to her computer screen. The system would then put a blinking red dot or other indicator at that place (or as close as possible on the screen) during recording, and tell the Contributor to look there when recording. If the Contributor has typed out her Contribution prior, the text of the Contribution may also appear at or close to the camera so that the final recording will show the Contributor looking into the camera instead of down or off to the side.

A Contributor may be able to make a trial recording to try out the system and get comfortable with how it works. She may also record and re-record until she is happy with her Contribution. She may be able to view her Contributions to see if she is happy with them.

The system of the present invention may also utilize eye-tracking hardware or software to create a better video if the person's head moves and/or if their eyes move. With this h/w and s/w, the camera or recording may move with the person's eyes. The system may also have a pause and record button.

The contributor may only have a limited amount of time for each recording or for the sum of their recordings. This may be imposed by the Organizer or by the system. The time allowed per recording may be shown to the Contributor. The teleprompter feature may utilize this time allowance to calculate how fast the Contributor will need to read.

In another embodiment of the present invention, a telephone system can be used for media/entry creation. A Contributor may call a certain phone number or dial a certain extension that may be assigned to that particular project to record her audio answer/Contribution(s). The system may have a recorded message that gives an overview of how many Contributions she has been requested to make and explain those Contributions. The voice of the recorded message may be of the Organizer or may be an automated computer voice. The Contributor would then be told by the phone system to press a key on the dial pad when she is ready to begin. If she has more than one question to answer (or more than one Contribution to make) she may press a key on the dial pad to indicate which Question she is answering (or Contribution that she is making, such as “Read your letter to Aunt Sally”). Once the key is pressed, the system would say the Question she is to answer (or name the description of the Contribution she should make) and tell her when to begin her recording. She may have the option to hear her recording and rerecord until she is satisfied. She may be able to press a key on the dial pad to indicate that she wants this recording saved and/or uploaded to the project. If she has further Contributions to make, she would press a key to move onto the next Contribution/Question, which the system would then say. She would begin the process again. Once all questions are answered, she would be told that her Contributions are complete. Once saved, this recording(s) would be automatically uploaded to the project and the Organizer may be able to edit it into the final product (book or video). Our system may also be able to transcribe audio recordings into text, to be used in final products.

The system may also be able to ask the Contributor to re-record her answer a few times at various speeds. The reason is because when audio is combined to make a final video production, there can be pacing and timing issues that make the final video seem choppy. For example, Uncle Sam may speak very fast and Sally may speak very slowly. When their audio contributions are put into a video, the fast and slow would disrupt the flow and style of the video. Having people speak at the same pace, rhythm, and rate would make for a nicer sounding final video. The system may help Contributors pace themselves by telling them how much time they should use to record, telling them to slow down (if the answer was given in too short of a time), telling them to speed up (if the answer was not given within the cutoff time), or giving them an example reading at the pace that is required. Pace timing may be set by a standard defined by the Organizer or by the system. For example, if the Organizer has chosen to have fast-paced music in the background then the speaking pace required may be faster.

The audio files recorded from the telephone system are then automatically uploaded into the system, possibly into the project and are viewable by the Organizer and anyone else whom they are shared with.

The telephone system may also be used if a person has not begun or completed her Contributions. The Contributor information may be pulled in from the Organizer's address book (Gmail, outlook, etc.) and may contain the Contributor's phone number or the Organizer may manually enter her phone number. If she has not begun contributing within x days of the start of the project, or opened the email about the project, then an automated phone call may be made to her, reminding her to start the project or asking her if she will be able to contribute by the deadline.

Another aspect of this invention relates to privacy. A Contributor may be able to choose whether or not she wants each of her contributions to be visible to others (public and/or other Contributors). This decision may be noted on a checkbox in the area where the Contributor makes the contribution or after she has saved the Contribution. The system may also have a consequence that if the Contributor does not share her Contribution, she may not be able to see other Contributor's contributions. The Organizer may be able to decide whether each Contribution must be made public, whether they are automatically private, or whether the Contributor can choose public or private. There may also be the ability for the Contributor or Organizer to share the product and/or Contributions with specified people or social networks.

### Marketing

In another aspect of the present invention, contributors can choose whether they want to be emailed information about other contributors and contributions. Information about these may come in the form of e-cards. In another aspect, there may be a feature that allows a user to tell another individual or company about the site and product.

A contributor may be able to select if she would like a copy of the final product when it is completed and may be able to pay for it herself.

An Organizer may select how many e-cards she wants to be in the final product (series of e-cards). She may select the frequency of automatically sending the e-cards or a time span to send the e-cards over.

### Product Creation (Books, Videos, etc.)

The system of the present invention may have the ability or give the Organizer the ability to assign certain Contributors and/or Questions to certain pages in a book or spots within a video. For example, the Organizer may decide Billy's Contribution to Question #1 will go on page 5 of a photo book and Billy's Contribution to Question#2 will go on page 6. Another example would be of the Organizer choosing to put the audio answers to Question #3 in the first part (perhaps 1:30 min-2:00 min) of the video. This may be done by the system generating a list of all Contributor/Question combos. So if there are 5 Contributors answering 3 questions each, then 15 Contributor/Question combos may be listed. Group Questions may be their “own combo” and act as 1 Contribution. In this embodiment, the Organizer can see all the pages of the book laid out in order. She could drag and drop each Combo onto each page to assign it. More than 1 combo may be assigned to each page and 1 combo may be assigned to many pages. If a contribution combo is not submitted, that page can later be deleted. (See attachment.) This can also be done with video and other final products.

In one aspect of the invention, text entries are shown as icons or thumbnail type of images, so that the organizer may easily drag and drop the text into the final product. For example, Sally's text answer to question 1 and Billy's text answer to question 1 may be shown in the product creation area as thumbnails, distinguishable from each other. The organizer may want to quickly grab Sally's text and drag it onto Sally's page in a photo book, so she will drag the thumbnail image onto the page into the designated text area, and Sally's full text answer to question 1 will be displayed and formatted to fit within the text box parameters. A combination of all of Sally's contributed media, or Sally's contributed media by question number, can also be selected with 1 click and dragged onto Sally's assigned space/page, where the appropriate areas are automatically populated with said media. For example, the Organizer grabs Sally's answer to Question 1 and contributed photo with 1 click and drags it to Sally's assigned page for Question 1, where the answer is automatically populated in the text box and the photo is automatically populated in the photo area.

When Contributors submit entries/contributions or media, the system may automatically put these entries into a common folder so the user may access all the media in one place when creating the final product, such as a photo book. The system may also tag all the media and entries with the Contributor(s) name/ID, date, project name/ID, and Question answered. These tags may be used by the system to pull up specific media as needed at a later time.

In a workspace area for creating the final product, a user may have an area with only the specifically assigned media for that area. For example, if working on pages 5-6 of a photo book, she may have an area with only Billy's pictures and text answers for Questions #1 and 2. This media would be automatically populated by the system based on the assigned pages and tagged media. In this embodiment, she would only see the contributed media that had been assigned for that part of the product.

In another aspect of the invention, the Organizer may leave space, pages, or portions of the final product un-assigned to Contributors or without a specified purpose. She may at a later date assign contributor's media or potentially contributed media, an Introduction page/space, a Conclusion page/space, a photo collage page/space, or a Group page/space. She may also assign pages/spaces to purposes of her own choosing, such as selecting 2 pages and entering “General Photos”. These assignments of pages/space in the final product could be visible to the Organizer on a storyboard type of layout, where she can drag and drop the assigned pages/space to create an order of media in the final product.

In another embodiment in the workspace area, would be for the user to check a checkbox next to each Question and/or each contributor's name (or choose from a dropdown box) whose contributed media she would like to see on the screen at that time. The chosen media may come up by media type or as combinations of media. (See attachment.) A single combo image would represent all the media a particular contributor had submitted for a particular question, such as a picture and text answer to Question #1. The user may then be able to lay out the media on the page as she wishes. Also, the system may automatically populate the pages and may allow the Organizer to edit the layout from there. She may also be able to edit the media (like cropping a picture or editing text) within that screen as well.

For a Group Question page, there would be 1 Question that all or many of the Contributors answered. The Organizer may see all the text contributions in the Contribution area as well as the Question. She may drag and drop the answers and question onto the page, according to how she wants it laid out. The page may also be automatically populated with all the answers and question by our system.

If a user edited a contribution, the original file would be saved and made so that it could be reverted back to or used later if desired.

Also, another user other than the Organizer, such as a contributor, may want to order a finished product for herself. Our system would allow the user to copy the existing finished product and then edit that to her liking. She could also start from a blank slate and use all the submitted media for the project that was not privacy protected from her, to create her own final product. She even may want to create a different final product such as calendar with the media that was originally submitted for a photo book. Either way, she would have access to the Contributed media to use to make the product how she likes it.

Another aspect of the invention relates to titling of pages or slides or other portions of a final product. The title may be automatically entered into the final product during product creation or entry creation. The title may be the question that was asked. For example, a page in a photo book may be titled or headed by the question “What is your favorite characteristic of Brenda?” and the center of the page may have a picture of the contributor with Brenda and the bottom of the page would have the contributor's answer. The title may also be the open statement form of the question, such as “My favorite characteristic of Brenda is . . . ”. The Organizer may choose to title the entry herself, set parameters for contributors to title the entry themselves, have the system automatically enter the title, and in which format the title should be automatically entered such as statement or question.

### Alternate Uses for the System and Method

In another aspect of the invention, the system and method described herein could be used by a commercial or non-profit corporation who wants to collect information from a specific group of people, such as customers, supporters, people they have helped, etc. This could be used for their own internal purposes, for marketing and advertising. For example, the question and answer format may be used for obtaining media (text, pictures, video and/or audio) from a group of users. The media collected from such users can be used to create a final product as described herein. For example, corporations utilizing our system could get customers to share pictures/videos with product and opinions/reviews about product in e-card format, see these entries for marketing/advertising campaign, or create social project where people come together. For example, a soap company can get women to share pictures/video of their soap and experiences and then pictures/video of new product experiences. This can be an easy way to create a marketing campaign, allow customers to share and comment on other contributions and allow a social sounding board for customers. Also, the invention could be used for a fundraiser for an issue like diabetes where people share stories or why they raise money for charity. This could be used for ads, fundraising pages, commercials and support boards for people who suffer from diabetes. Companies may also use the invention for marketing purposes including e-card like contributions to be shared to social media and thus advertising. E-cards could be tweeted on twitter for advertising and sharing of entries.

One example is that our system could be used to integrate with a system that collects your family history. The system may be a front-end system for another system such as a genealogy site. The system may both collect data for a project with the intention to store the data and also be the front end to a data storage solution other then a photo company, which would allow us to pull media from the database of stored data. For example, after people add their up to date past images and memories, our question and answer system could be used to gather all meaningful components for future events. For example, Joe is 65 and has built his past history through images and, documents like report cards, and letters. Joe will live for another 20+ years and wants to make sure he captures future memories and maybe even some additional details about past memories. Our system could push data into their system or a genealogy system or a family tree system or other related system. They could use the year in review concept with invitations to other family members such as asking for contributions for an upcoming 70th birthday for mom or to commemorate the birth of a grandchild. In addition, a system like a data management family history system could also be a source of data fir the users final products. By pulling the data from this central repository it would be very easy to build a special gift but also put the data from others into this repository.

In one aspect of the invention, it may be sold as a final product kit or unmade final product that can be completed by a user at a later date.

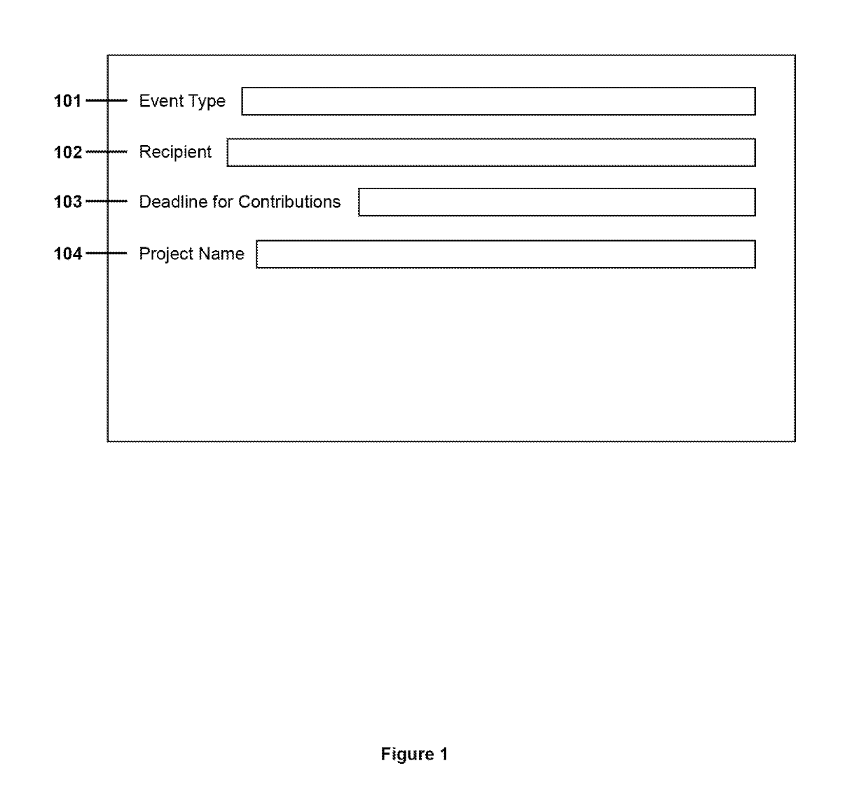

Turning to the Figures, FIG. 1 is an exemplary GUI for an organizer to begin a project with. Fields 101, 102, 103 and 104 can be a variety of entries. In this example, field 101 is shown to correspond to “Event Type,” field 102 is shown to correspond with “Recipient,” field 103 is shown to correspond to a “Deadline for Contributions” and field 104 is shown to correspond with “Project Name.” The entries are no limited to these fields but allow an organizer to input information relating to these fields and create parameters for the project. Another example of a parameter is a theme.

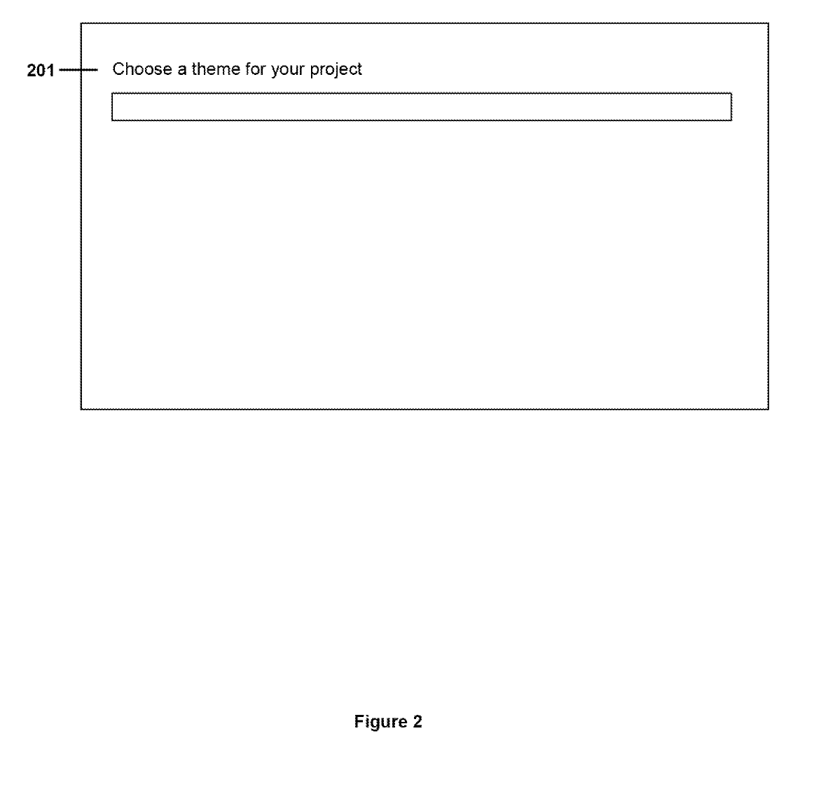

FIG. 2 is an exemplary GUI for an organizer relating to theme choice. An organizer can assign a theme freeform and enter it into field 201 or choose one from a drop-down menu in field 201.

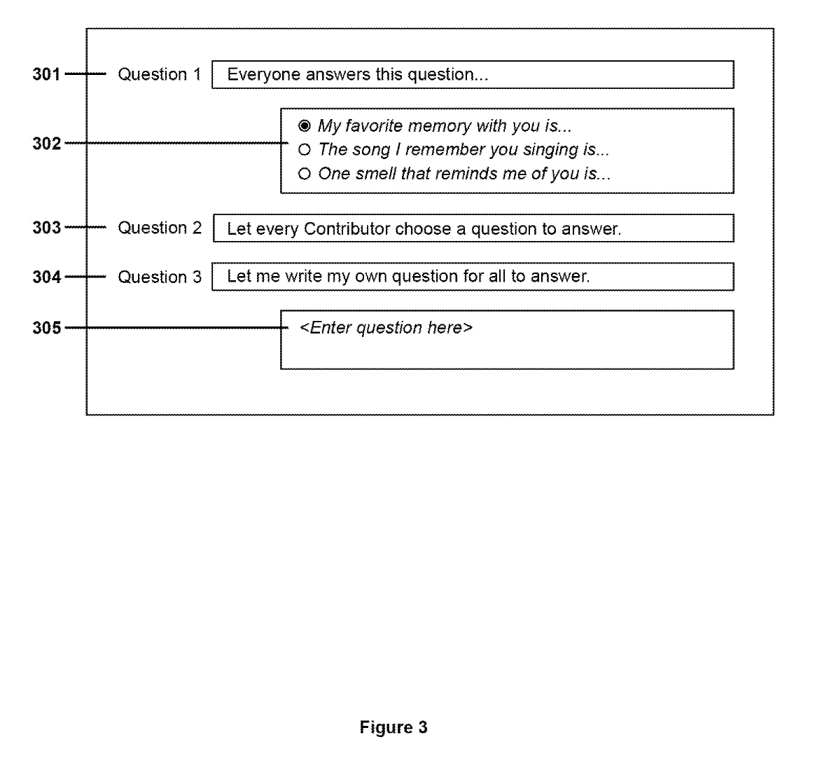

FIG. 3 is an exemplary GUI for an organizer relating to theme choice in more detail. Fields 301-305 exemplify a variety of questions that an organizer can create or choose from a predetermined set of questions. Field 305 allows an organizer to freeform a question.

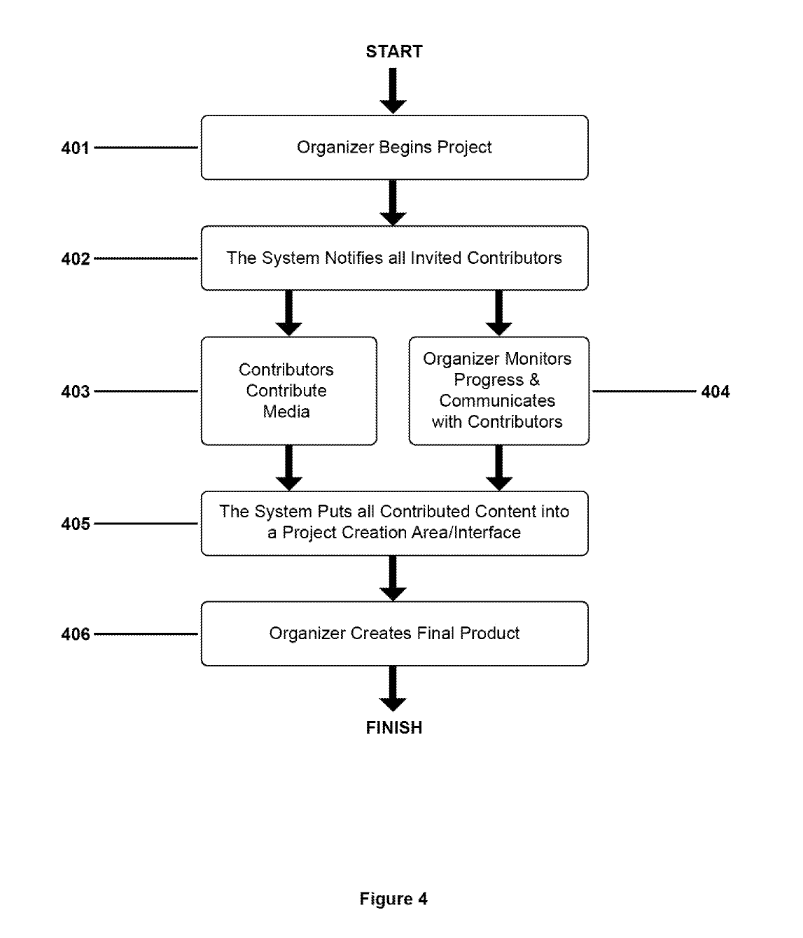

FIG. 4 is an exemplary flowchart of the system of the present invention. An organizer begins or initiates a project at 401. Once the organizer has begun or initiates a project at 401, the system notifies the invited contributors as shown at 402. Organizer can choose the invited contributors. Once the system has notified the invited contributors (via email, SMS, etc.) the contributors begin to contribute media at 403 and the organizer monitors progress and communicates with contributors at 404. Then the system puts all the contributed media/content into a project creation area or interface at 405. Once the system has assembled the media/content, the organizer creates a final product at 406.

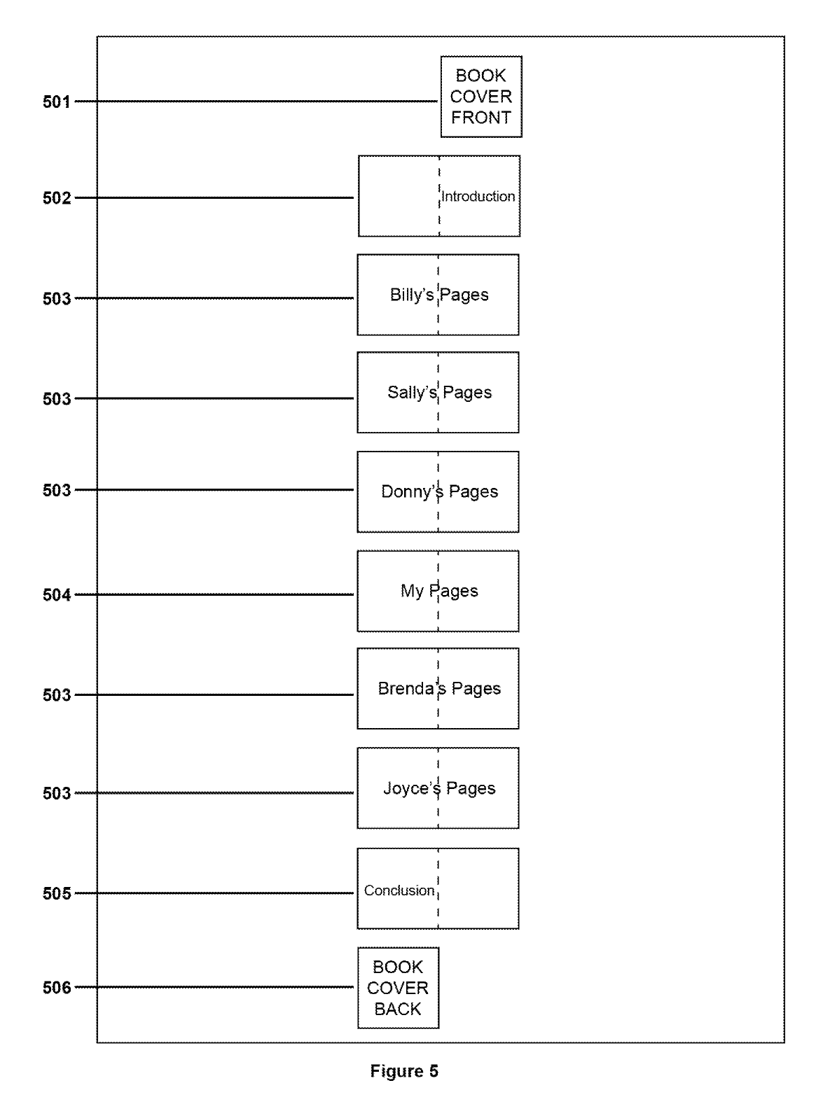

FIG. 5 is an exemplary project creation area showing assignment of pages to various contributors. The front image of the final product (shown as a book in this example) is shown at 501. An introduction is shown at 502. Various contributors' pages are shown at 503. The organizer's page is shown at 504. Conclusion page 505 and back cover page 506 are also shown. In project creation area, space can be automatically allotted by the system for an introduction page/video message and a conclusion page/video message. Users may have access to a library of quotes to help in generating content for these pages. Contributed media is assigned to a user and the user's name who contributed the media is visible to the organizer through the GUI so that the organizer can order the contributions in a manner the organizer deems fit.

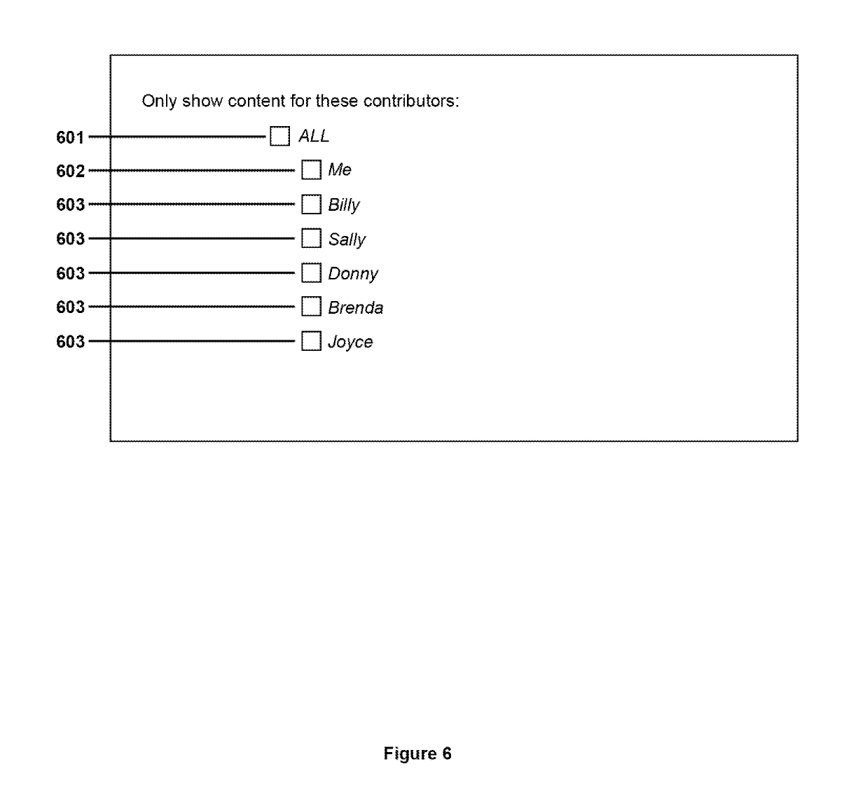

FIG. 6 is an exemplary GUI, which enables hiding and showing media by a contributor within a Product Creation area. The contributor can select “ALL” at 601 or select one or more contributors individually at 602 (the organizer) or 603 (the contributor).

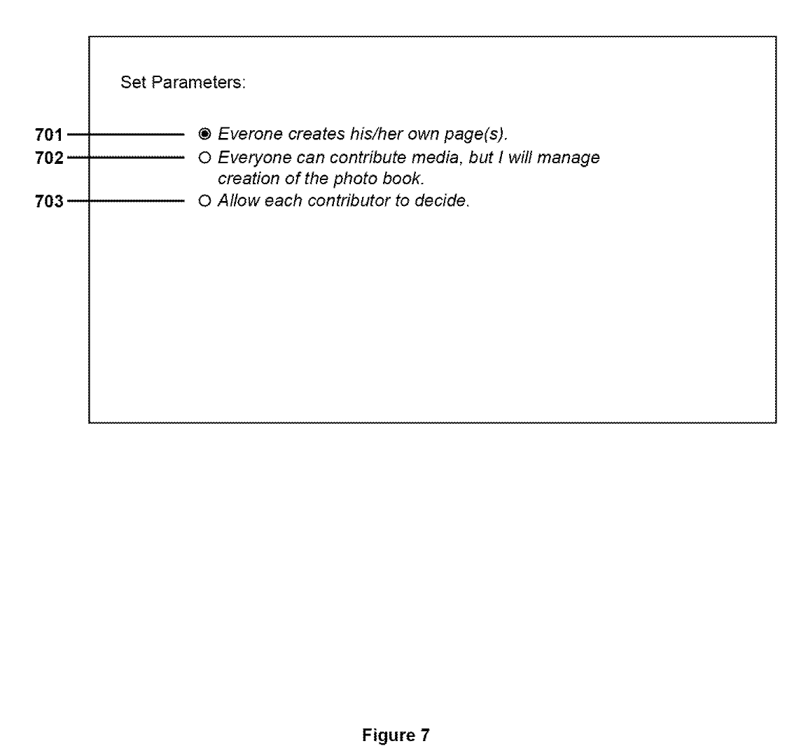

FIG. 7 is an exemplary GUI showing setting of various parameters. Features 701-703 show examples or these various parameters that an organizer can choose. The organizer can set parameters for contributions and manage them. The organizer may allow contributors to submit media and the organizer will place it all in the final product. Alternatively, the organizer may assign or have the system assign pages/space to Contributors and let them create their own portion of the final product.

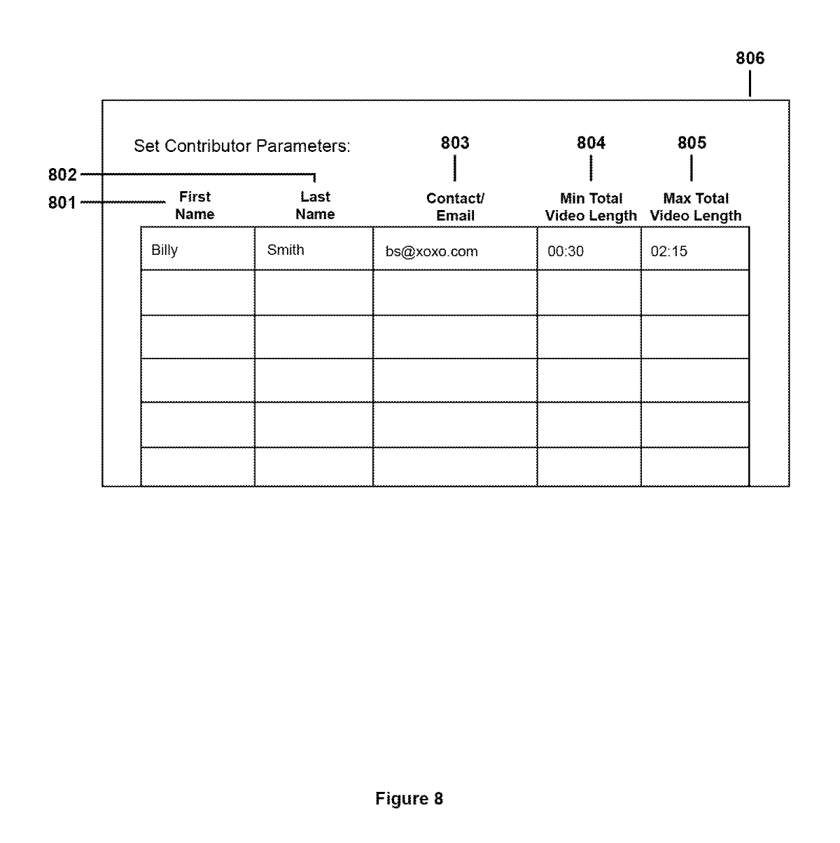

FIG. 8 is an exemplary GUI used by an organizer to obtain video contributions. An organizer can set various contributor parameters, such as first name 801, last name 802, contact/email 803, minimum video length 803 and max total video length 804 within GUI 806. An organizer can decide on a range (min and max) amount of input (number of book pages or video time or total number of characters in text content, for example) for each contributor. The amount of requested input (number of book pages or video time or total number of characters in text content, for example) can be equally divided among and assigned to contributors.

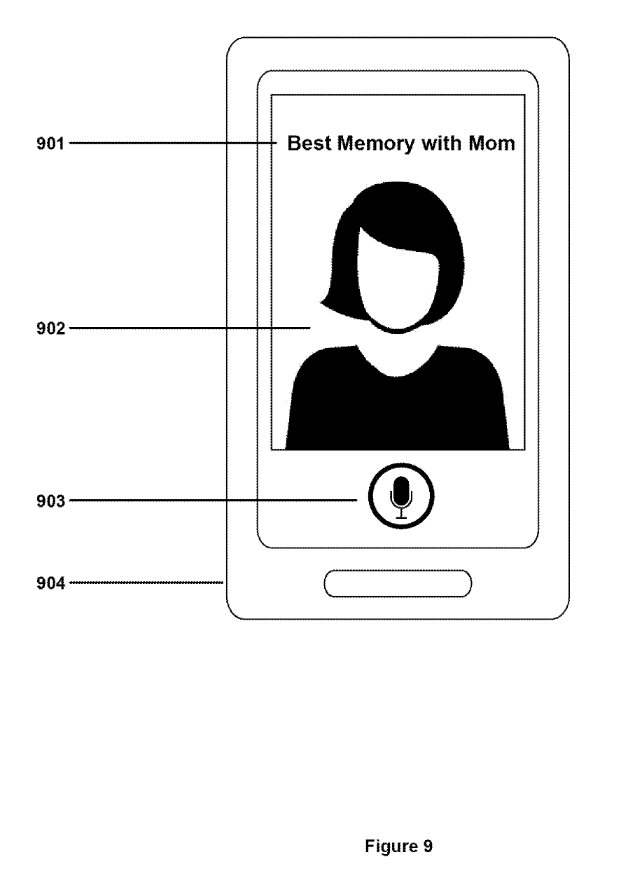

FIG. 9 is an exemplary phone application a contributor can use to record a contribution. A parameter 901 is shown the top of a screen, showing an image 902 and record button 903, on phone or other electronic device 904.

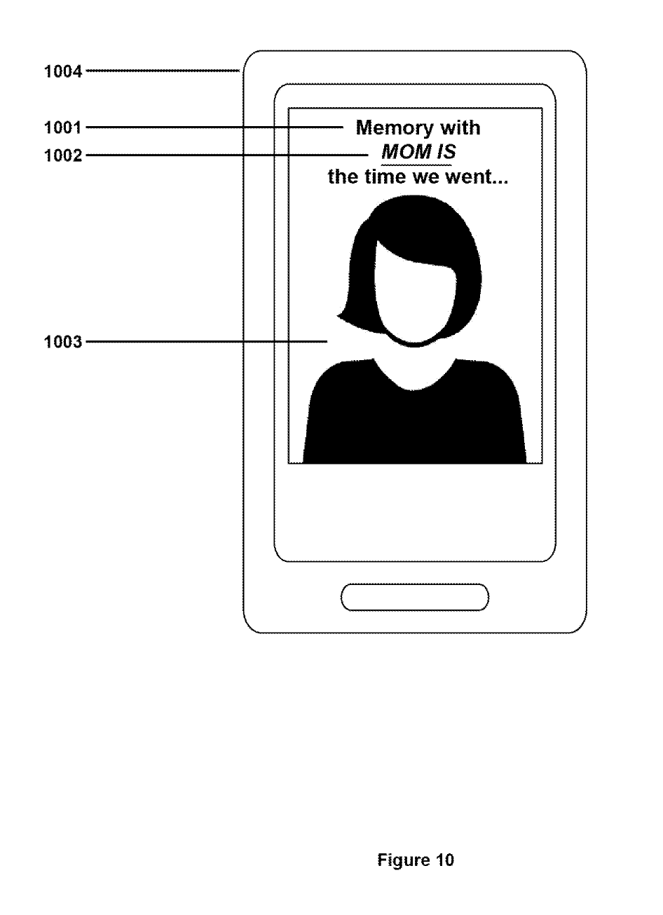

FIG. 10 is an exemplary phone application showing a scrolling feature a contributor can use to read a contribution. As a user scrolls through the text, the top line disappears as a new line appears at the bottom of the screen. There can be also be a functionality to show the user what words to read at what time by capitalizing the words that a reader is supposed to read at a particular time. Instead of capitalizing, there can also be functionality that italicizes, underlines, highlights, colors, or otherwise particularly notes the text to be read. This allows the system to control the pace at which a reader reads the text and provides uniformity among the various contributors. Also, if music is added, the pace at which a reader reads can be timed with the music.

A user can speak or type words that are her contribution or a portion of contribution. The theme question or a phrase from the theme/question may be displayed across the top of the screen to help a user. A user's spoken words may be transcribed automatically by the system. The system shows the text of her contribution at a specific pace and in a scrolling manner, so that she may read and record it at a specific pace or cadence. This timing can be similar for all contributors so that the final product has a common cadence and is not rhythmically choppy from a variety of contributors.

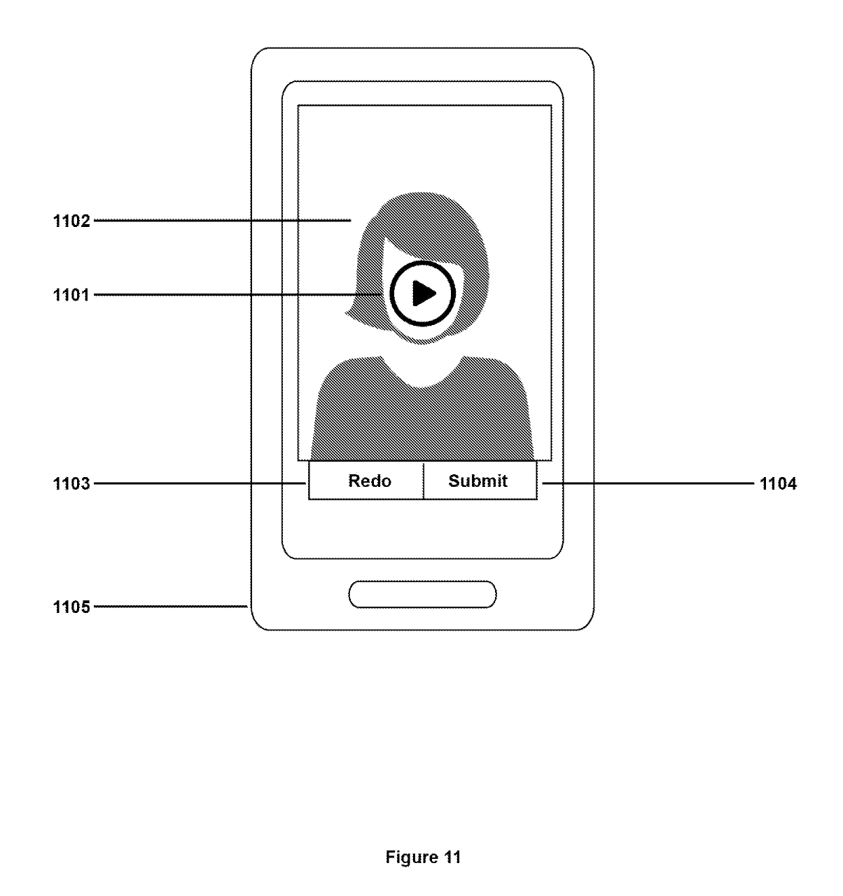

FIG. 11 is an exemplary phone application where a contributor can play a video and choose whether to redo the contribution or submit/upload the contribution. A contributor can replay the contribution by pressing play button 1101 while viewing a frame of the video image 1102 on phone or other electronic device 1105. Redo button 1103 and submit buttons 1103 and 1104, respectively, are available for the contributor to actuate the functions.

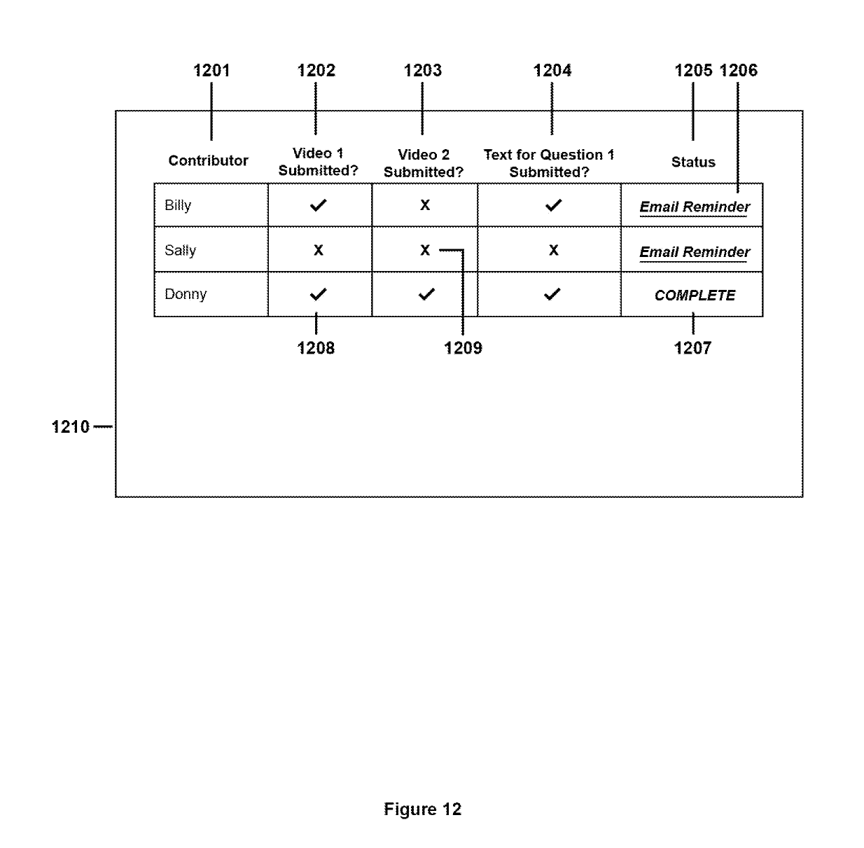

FIG. 12 is an exemplary dashboard 1210 of an organizer to track the status of contributions. For example, the names of the contributors are listed at 1201, whether first or second videos were submitted is at 1202 and 1203, respectively, whether text for questions is submitted is at 1204 and status at 1205. Under status, an email reminder 1206 can indicate that follow up is required or completion can be shown at 1207. Check mark 1208 and X mark 1209 can be used to easily convey to the organizer which tasks have been completed and which remain. The dashboard can also list the contributors and status on how much each has contributed. It can be dynamic, i.e., updated in real time. The exemplary dashboard can also allow the organizer to contact the contributors with reminder emails, and track when and the method of how prior messages were sent.

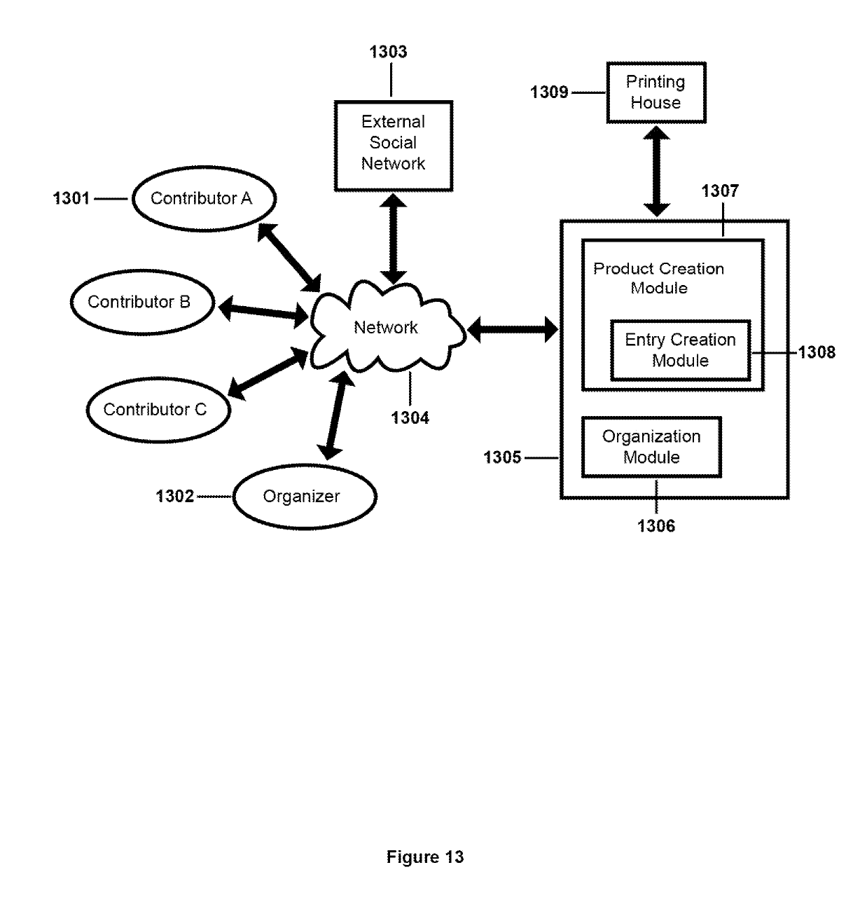

FIG. 13 is an exemplary system diagram. Contributors 1301 and organizer 1302 can communicate information, data, and/or media to network 1304. An external social network 1303 may also be communicating with network 1304. Network 1304 provides information/data relating to the product to module 1305 which can comprise of a product creation module and organization module. Within the product creation module 1307 can be an entry creation module 1308. Module 1305 in turn communicates with a printing house 1309, for example, to create/publish a final product.

### Other Features

Requested input amount per contributor and or total input amount (number of pages or video time) can be computed through an algorithm that factors song length, length of a combination of songs, or other predetermined time span or amount of contributed media.

An organizer can be prompted to upload, attach or connect an image of the gift or product recipient which will be sent in an email to potential contributors to incite emotion and a stronger desire to contribute quality media.

A checkbox or option for contributor can be provided to the contribution content private to only the contributor and the recipient and not made part of and not made public. An option may exist that allows the Organizer and Recipient to see the contribution or portion of the contribution, but no one else.

A telephone system can also be provided to instruct the contributor, that reads the questions to the contributor and allows him to answer, record the contributors answers, allow the contributor to re-record, allow the contributor to save and submit the audio recording to the project, and uploads audio file to project online. This telephone system may instruct the contributor to answer question 1 within a specified time that may be limited by the Organizer. The system may instruct the contributor when to record with a sound such as a beep. It may read question 1 to the contributor, allow him to collect his thoughts, notify him its time to record, beep, record his answer, beep at the end, then allow the contributor to save or redo. This may happen for all requested questions. The system may upload the audio directly into the Organizers dashboard or the product creation area. The telephone system may also transcribe audio files into text. The system may also allow the contributor to press any key when he is ready to record and press any key when he is finished that recording.

A checkbox or option for the contributor to allow or request an organizer to edit or add to her media and/or final contribution can also be provided.

Contributor or organizer can click a “Save for Later” button or a “Submit to Project” type of button.

Contributed content or media such as text from every contributor is assigned to pages or space, such as 1-2 pages, in the final product in an automatic manner, such as a Group page. Contributors may enter their name or nickname or name that they are called by the Recipient. The name from each contributor may be automatically put after the contributors' media in the Group page. For example, a Group page may be titled “Our favorite characteristics of Grandma”. It could be followed by content such as “Smart-Billy”, “Witty-Bob”, or “Generous-Patti”. Page layouts, page templates, or video templates may exist to allow for group content. In the product creation area, the system may pull in media from each contributor that has been designated for a Group page.

Video may be analyzed with speech recognition software to create or edit video or audio files into the final product.

Icons representing contributions, such as text or audio icons, can also be provided such that the specific contribution is identified with colors or characters or the file is renamed. For example, an audio file from Brenda that answers Question #3 may be a speaker icon with a “Br3”. Alternatively, the file may be renamed Brenda 3. A text contribution from Joyce Bishop may be a pink text icon with a “JB”, where all of Joyce Bishop's contributed media icons are pink.

The present invention is not limited to the specific embodiments and examples described herein. Further adaptations of the methods and systems describe herein may be accomplished by modifications by one of ordinary skill in the art without departing from the scope of the present invention.

1. A computer-implemented method to create a collaborative product, the method comprising:
selecting, by a first user, one or more second users to contribute media to the collaborative product;
establishing, by said first user, at least one parameter for the collaborative product;
establishing, by said first user, at least one parameter for the media to be contributed;
selecting, by said first user, a theme for the collaborative product;
contributing, by said one or more second users, media for the collaborative product; and
using, by said first user, one or more second user's media to create the collaborative product.

2. The method of claim 1, wherein said collaborative product is one or more of a video, personalized book of text, slideshow, video montage, audio file, calendar, collage, newsletter, mixed media story, cards, series of printed cards or series of e-cards, slideshow, video montage, audio file, photo book, scrapbook, or photo album.

3. The method of claim 1, wherein said media is one or more of video, audio, text, pictures, photographs, electronic artwork, digital or online album, photo album, photo story, photo book, photo book page(s), online photo book, card, electronic card, collage, newsletter, invitation, message, calendar, portion of a calendar, website, webpage, any photo or video product, a portion of any photo or video product.

4. The method of claim 1, wherein said at least one parameter is one or more of the following: recipient, event, theme, date of the event, project name, specific questions to be answered, how many or few questions to answer, format of contributions, deadlines, type of media, minimum amount of media, maximum amount of media, number of characters in text, number of pages, minimum video time, maximum video time, names of second users, number of second users, information relating to second users, type and format of the collaborative product(s), and degree to which second users may edit their assigned portion of the collaborative product.

5. The method of claim 1, wherein questions relating to said theme are posed to said one or more second users.

6. The method of claim 1, wherein said first user limits the amount of media contributed by the one or more second users.

7. The method of claim 1, wherein said media is associated with one or more second users who contributed said media and said association is communicated to said first user.

8. The method of claim 1, wherein said first user is able to edit parameters and said one or more second users is able to edit media.

9. The method of claim 1, wherein said contributed media is loaded into a product creation area for said first user to view and select from.

10. The method of claim 1, wherein a graphical user interface is used by said first user to view and monitor contributions.

11. A computerized system capable of creating a collaborative product, the system comprising:
means for a first user to select one or more second users to contribute media to the collaborative product;
means for the first user to establish at least one parameter for the collaborative product;
means for the first user to establish at least one parameter for the media to be contributed;
means for the first user to select a theme for the collaborative product;
means for the one or more second users to contribute media for the collaborative product; and
means for the first user to use one or more second user's media to create the collaborative product.

12. The system of claim 11, wherein said collaborative product is one or more of a video, personalized book of text, slideshow, video montage, audio file, calendar, collage, newsletter, mixed media story, cards, series of printed cards or series of e-cards, slideshow, video montage, audio file, photo book, scrapbook, or photo album.

13. The system of claim 11, wherein said media is one or more of video, audio, text, pictures, photographs, electronic artwork, digital or online album, photo album, photo story, photo book, photo book page(s), online photo book, card, electronic card, collage, newsletter, invitation, message, calendar, portion of a calendar, website, webpage, any photo or video product, a portion of any photo or video product.

14. The system of claim 11, wherein said at least one parameter is one or more of the following: recipient, event, theme, date of the event, project name, specific questions to be answered, how many or few questions to answer, format of contributions, deadlines, type of media, minimum amount of media, maximum amount of media, number of characters in text, number of pages, minimum video time, maximum video time, names of second users, number of second users, information relating to second users, type and format of the collaborative product(s), and degree to which second users may edit their assigned portion of the collaborative product.

15. The system of claim 11, wherein questions relating to said theme are posed to said one or more second users.

16. The system of claim 11, wherein said first user limits the amount of media contributed by the one or more second users.

17. The system of claim 11, wherein said media is associated with one or more second users who contributed said media and said association is communicated to said first user.

18. The system of claim 11, wherein said first user is able to edit parameters and said one or more second users is able to edit media.

19. The system of claim 11, wherein said contributed media is loaded into a product creation area for said first user to view and select from.

20. The system of claim 11, wherein a graphical user interface is used by said first user to view and monitor contributions.
